(19) United States
(12) Patent Application Publication
(10) Pub. No.: US 2014/0050203 A1
(43) Pub. Date: Feb. 20, 2014

(54) Apparatus and Method for Radio Systems Co-Existence on Secondary Carriers

(71) Applicants: Klaus Doppler, Albany, CA (US); Jarkko Kneckt, Espoo (FI)

(72) Inventors: Klaus Doppler, Albany, CA (US); Jarkko Kneckt, Espoo (FI)

(73) Assignee: NOKIA CORPORATION, Espoo (FI)

(21) Appl. No.: 13/980,130

(22) PCT Filed: Jan. 26, 2011
(86) PCT No.: PCT/IB2011/050346

§ 371 Date: Sep. 24, 2013

(51) Int. Cl. H04W 16/10

(52) U.S. Cl. CPC H04W 16/10
USPC 370/336; 370/329

(57) ABSTRACT

A mechanism for radio systems co-existence on secondary carriers may be of particular value to radio systems that that operating on the same bands as Wi-Fi™ (2.4 GHz, 5 GHz, or the like) or the bands of similar radio systems. A method providing such a mechanism may include operating Provide Wireless a first network node of a first radio network on a primary channel. The method may also include identifying a secondary channel for expanded operation of the first network node. The method may further include providing a second network node with an opportunity to capture the secondary channel.

### BACKGROUND

1. Field

An apparatus and method for radio systems co-existence on secondary carriers may be of particular value to radio systems that are operating on the same bands as Wi-Fi™ (2.4 GHz, 5 GHz, or the like) or the bands of similar radio systems.

2. Description of the Related Art

Unbalanced utilization of radio frequency (RF) bands can lead to spectrum scarcity. Spectrum scarcity can be addressed various ways. For example, opportunistic and non-collaborative techniques can be used. Alternatively, spectrum access scheduling can proactively structure and interleave the channel access pattern of heterogeneous wireless systems. Various techniques for addressing unbalanced utilization of RF bands can be applied to femtocells and cognitive radios, which can share the RF spectrum that was originally allocated to primary spectrum users. Other techniques can treat all wireless systems as equals, and cause the wireless systems to intentionally allow others channel access, for example, using a time division multiple access (TDMA) approach.

In particular, the local area radio network system can adhere to a flexible spectrum use (FSU) principle that provides a way for local area radio network radios to cooperate and select the non-overlapping channels for their use. In particular, local area radio network radios can use flexible spectrum and use principles related to the use of flexible spectrum to enable co-existence between local area radio network radios.

There are ways to empty unlicensed bands from Wi-Fi™ radios and capture the spectrum to local area radio network radio. That approach may not be viewed as a polite co-existence mechanism, but rather may be viewed as a brute force solution.

Multiradio techniques provide co-existence among Bluetooth®, third generation (3 G) and wireless local area network (WLAN) radios that are all implemented on the same device. These techniques are typically related to modem enhancements and capability to schedule transmissions in a certain order. These techniques may address a single user equipment (UE) operation dilemma but do not focus on the whole radio system interoperation.

### SUMMARY

In certain embodiments a method is provided including operating a first network node of a first radio network on a primary channel. The method also includes identifying a secondary channel for expanded operation of the first network node. The method further includes providing a second network node with an opportunity to capture the secondary channel.

A computer readable medium encoded with computer instructions that, when executed in hardware, perform a process, is provided in certain embodiments. The process includes operating a first network node of a first radio network on a primary channel. The process also includes identifying a secondary channel for expanded operation of the first network node. The process further includes providing a second network node with an opportunity to capture the secondary channel.

Certain embodiments provide an apparatus including at least one memory including computer program instructions and at least one processor. The at least one memory and the computer program instructions are configured to, with the at least one processor, cause the apparatus at least to operate a first network node of a first radio network on a primary channel. The at least one memory and the computer program instructions are also configured to, with the at least one processor, cause the apparatus at least to identify a secondary channel for expanded operation of the first network node. The at least one memory and the computer program instructions are further configured to, with the at least one processor, cause the apparatus at least to provide a second network node with an opportunity to capture the secondary channel.

An apparatus, in certain embodiments, is provided including operating means for operating a first network node of a first radio network on a primary channel. The apparatus also includes identifying means for identifying a secondary channel for expanded operation of the first network node. The apparatus further includes providing means for providing a second network node with an opportunity to capture the secondary channel.

A method in certain embodiments includes operating a network node in a first radio network on a primary channel and a secondary channel. The method also includes receiving, at the network node, a configuration that the secondary channel is in co-existence mode. The method further includes applying a co-existence strategy to operation in the secondary channel.

In certain embodiments, an apparatus includes at least one memory including computer program instructions and at least one processor. The at least one memory and the computer program instructions are configured to, with the at least one processor, cause the apparatus at least to operate a network node in a first radio network on a primary channel and a secondary channel. The at least one memory and the computer program instructions are also configured to, with the at least one processor, cause the apparatus at least to process a received configuration that the secondary channel is in co-existence mode. The at least one memory and the computer program instructions are further configured to, with the at least one processor, cause the apparatus at least to apply a co-existence strategy to operation in the secondary channel.

An apparatus, in certain other embodiments, includes operating means for operating a network node in a first radio network on a primary channel and a secondary channel. The apparatus also includes processing means for processing a received configuration that the secondary channel is in co-existence mode. The apparatus further includes control means for applying a co-existence strategy to operation in the secondary channel.

A computer readable medium encoded with computer instructions that, when executed in hardware, perform a process, is provided in certain embodiments. The process includes operating a network node in a first radio network on a primary channel and a secondary channel. The process also includes receiving, at the network node, a configuration that the secondary channel is in co-existence mode. The process further includes applying a co-existence strategy to operation in the secondary channel.

### BRIEF DESCRIPTION OF THE DRAWINGS

For proper understanding of the invention, reference should be made to the accompanying drawings, wherein:

FIG. 1 illustrates a situation that can occur when a Wi-Fi™ system co-exists with an LTE system, such as a local area radio network.

FIG. 2 illustrates a co-existence scheme according to certain embodiments.

FIG. 3 illustrates an idle period and following carrier sensing used as reservation mechanism for the following reservation period.

FIG. 4 illustrates signaling according to embodiment of the present invention.

FIG. 5 illustrates a signaling mechanism according another embodiment of the present invention.

FIG. 6 illustrates a method according to certain embodiments of the present invention.

FIG. 7 illustrates an apparatus according to certain embodiments of the present invention.

FIG. 8 illustrates another method according to certain embodiments of the present invention.

FIG. 9 illustrates another apparatus according to certain embodiments of the present invention.

### DETAILED DESCRIPTION OF THE PREFERRED EMBODIMENT(S)

A local area radio system can complement existing cellular wide area systems, such as the Global System for Mobile Communication (GSM), Universal Mobile Telecommunications System (UMTS), High Speed Packet Access (HSPA) or Long Term Evolution (LTE). Unlike typical wide area cellular systems, a local area system or heterogeneous system can utilize the license-exempt spectrum and time division duplex (TDD) bands to take advantage of the additional available bandwidth.

Wireless local area network (LAN) systems based on Institute of Electrical and Electronics Engineers (IEEE) standard 802.11, can operate on the 2.4 GHz and 5 GHz license exempt bands, which may also be used by local area radio systems.

Although IEEE 802.11n devices may apply 2*20 MHz=40 MHz transmission width, IEEE 802.11ac devices may be able to use 8*20 MHz=160 MHz transmission width and classify the applied channels into primary, secondary, tertiary, quaternary, quinary (5), senary (6), septenary (7), and octonary (8) channels. All other channels than primary channel may be referred to as secondary channels. The primary channel is organizing the transmissions, i.e. obtaining transmission opportunities (TXOPs), while the secondary channels may be used to carry traffic during the transmission opportunity, if these channels have been idle at least a point coordination function (PCF) interframe space (PIES) before the transmission opportunity initiation.

A local area radio network base station (BS) transmits broadcast channel (BCH) and control channels on a primary channel, Wi-Fi™ the beacons and both systems can use it for data transmission as well. If the capacity on the primary channel is not sufficient, both systems have a mechanism to take additional channels into use.

If both the local area radio network base station and Wi-Fi™ access point (AP) have detected uncooperative interferer, they will likely select different primary channels for their operation. The secondary, tertiary and quaternary channels of the WI-Fi radio are defined by the position of the primary channel, while the other secondary channels may be freely selected by the access point. The criterion for secondary channel selection is typically not as strict as for primary channel selection and it is more likely that local area radio network and wireless local area network will use the same channels as their secondary channels.

The logic to select the primary or secondary channel can be performed in any suitable way. Once the primary and secondary channels are selected, certain embodiments of the present invention enable co-existence of the local area radio network and wireless local area network radios on the selected channels. Secondary channels can be taken into use in certain (predefined) order or that some secondary channels are more often used than others. The radio systems may consider minimizing the capacity loss of the co-existence by co-existing only on secondary channels that are the most seldom used by the other radio system, or radio systems, in the area.

Local area radios may consume a significant amount of bandwidth attempting to increase the throughput of transmitted traffic. The need for bandwidth can easily result in the use of the same resources. Therefore, a co-existence mechanism can be used to enable efficient co-existence for both systems.

A co-existence solution can have various characteristics. For example, a co-existence solution may not require any or little signaling between access points of the different systems. It should be noted that “access points” and “base stations” may be used interchangeably in this discussion. Thus, both systems can be said to have “base stations” and both systems can be said to have “access points,” referring to the same devices by both names.

Moreover, a co-existence solution can respect the operating principles of both systems and require minimum changes to existing standards. Thus, a co-existence can be as friendly as possible to each of the radio systems.

However, providing for co-existence of a scheduled system with frame-based timing and a contention based system may be challenging, because the systems operate using different resource allocation logic and the systems are typically not able to exchange signaling with one another. IEEE 802.11ac may further complicate co-existence, because devices may use also the secondary channels for data transmission.

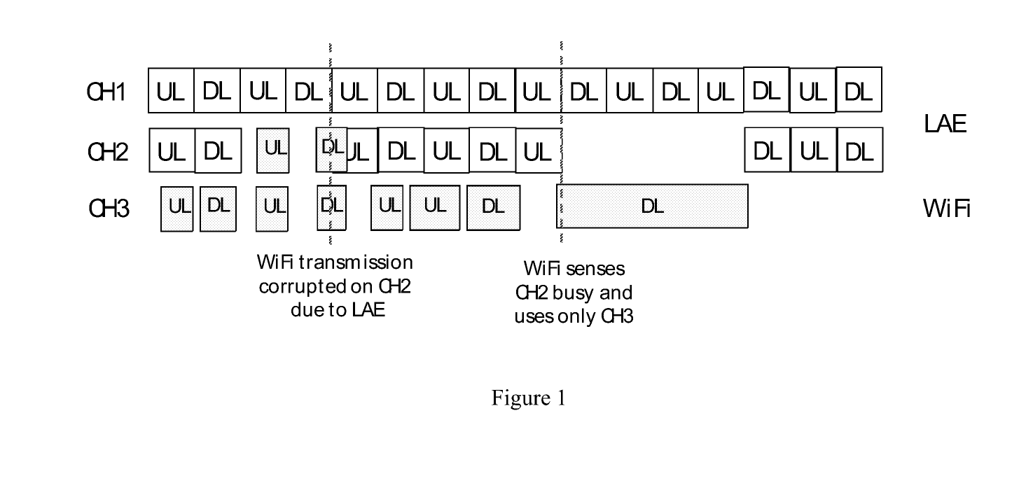

FIG. 1 illustrates a situation that can occur when a Wi-Fi™ system co-exists with an LTE system, such as a local area radio network. At first both systems may try to avoid un-cooperative interferers and consequently may choose different channels for their primary operation, CH1 and CH3 in FIG. 1. Wi-Fi™ will, in this example, transmit beacons and local area radio network will transmit broadcast channels and selected control channels. Further, both systems will operate on the selected channel.

However, in this example both systems have a mechanism to take other channels into use when there is a capacity need. Both may select CH2 as a secondary channel.

More specifically, FIG. 1 illustrates Wi-Fi™ and local area radio network co-existence on 3 channels. Wi-Fi™ has, as illustrated, CH3 as its primary channel and uses CH2 if needed and sensed idle. The local area radio network uses CH1 as its primary channel and takes CH2 into use if needed.

FIG. 1 illustrates two cases in the co-existence where mostly Wi-Fi™ suffers. First, Wi-Fi™ transmission is hit by local area radio network transmission. The local area radio network does not use carrier sensing and starts its operation in CH2 when the access points decides to schedule users. In this case both transmissions will likely be corrupted. Second, Wi-Fi™ senses CH2 busy and does not transmit on CH2 even though it would be empty during most of the transmission time. Without coordination, Wi-Fi™ may try at random time to take CH2 into use and will sense that it is busy. As a result of sensing that CH2 is busy, Wi-Fi™ does not take it into use.

The first described case may lower the achievable throughput in both systems. In contrast, the second described case will mainly affect the Wi-Fi™ system.

Certain embodiments of the present invention provide modifications to the local area radio network system that can avoid both cases and enable an efficient co-existence solution for Wi-Fi™ and a local area radio network with no—or very limited—signaling between the systems.

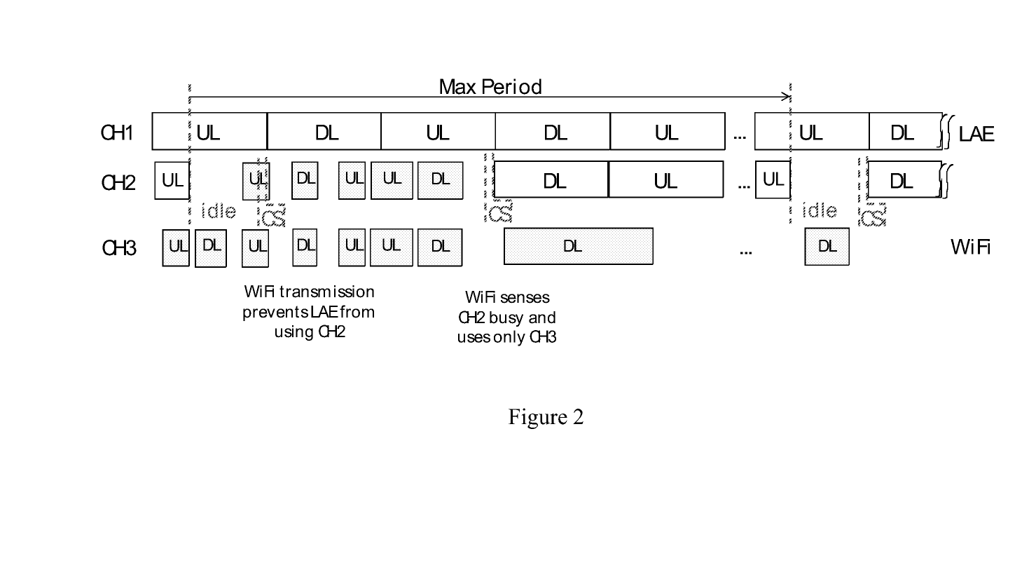

Thus, in the coexistence scheme of certain embodiments, the local area radio network access point lets contention based systems capture bandwidth that is reserved for the local area radio network access point. The mechanism can also specify operation rules for local area radio network access point to recapture the channel for its usage and bandwidth allocation rules. FIG. 2 illustrates a co-existence scheme according to certain embodiments. More specifically, FIG. 2 illustrates a co-existence scheme in which idle periods and carrier Sensing on secondary carriers are introduced to facilitate co-existence with Wi-Fi™.

The following features can be performed by an enhanced Node B (eNB), a home eNB (HeNB), or a device-to-device (D2D) master node: detect the activity of another system; continue normal operation on a primary cell (component carrier); and start co-existence mode on a secondary cell (component carrier). The terms “primary cell” and “primary component carrier” can be used interchangeably, as can “secondary cell” and “secondary component carrier.” Additionally, the eNB or master node can signal to user equipment that the secondary component carrier is now configured for co-existence mode (radio resource control signaling RRCConnectionReconfiguration message with LTE_Bus_Timeout and starting frame number for first reservation as information elements).

If a user equipment has the component carrier configured as its primary cell, a handover can be initiated to a new primary cell and the component carrier can be configured as a secondary cell in co-existence mode (RRCConnectionReconfiguration message with LTE_Busy_Timeout and starting frame number for first reservation as information elements). Thus, a user equipment can always have a primary cell (primary component carrier).

Additionally, the gaps can be created in the signaling at pre-defined intervals to allow Wi-Fi™ or the like to start activity. Additionally, the channel can be sensed after these gaps, while not sensing the channel otherwise. Furthermore, if a transmission of the other system is sensed (for example, using feature detection or energy detection) during the carrier sensing period, it can be interpreted as a reservation period until the next gap or for a pre-determined period (LTE_Busy_Timeout).

The base station (for example, eNB or master node) can inform the user equipment on another component carrier that the secondary component carrier will be unavailable for the LTE_Bus_Timeout period. Informing can be preferably performed as broadcast message in a system information block in a system information block. No reactivation message may be required, because reactivation may be understood to occur implicit when the LTE_Busy_Timeout period terminates.

The user equipment may respond specifically to these messages. For example, the user equipment may get a secondary component carrier configured radio resource control signaling, such as an RRCConnectionReconfiguration message, which indicates a co-existence mode. The new information elements LTE_Busy_Timeout and frame number where the sensing will be done can be signaled to the user equipment.

If a secondary component carrier is in co-existence mode, the user equipment can know the subframes when—and the LTE_Busy_Timeout duration during which—the component carrier will not be available. If the user equipment does not receive the packet data control channel (PDCCH) for 2-5 times after the sensing, it can stop scanning for the PDCCH and start again after the duration is over.

Alternatively, if the UE receives on another component carrier a message that the component carrier is not available for the reservation period, the user equipment can stop scanning for the PDCCH and start again after the duration is over.

If the user equipment is in discontinuous reception (DRx) it can wake up to receive the message, for example a system information block on a broadcast channel. The eNB can schedule the user equipment in DRx mode to channels that do not operate in co-existence mode, Alternatively, the eNB can signal the state of the secondary component carrier in co-existence mode to the user equipment in a media access control (MAC) control element (CE).

The local area radio network radio can organize an opportunity to wireless local area network radio to capture the secondary channel. The media capturing may be organized through, for example, use of carrier sensing (CS) on secondary channels and idle periods to allow Wi-Fi™ operation.

Use of carrier sensing on secondary channels can be performed by the local area radio network base station. At a minimum, the local area radio network base station can use the last two orthogonal frequency-division multiplexing (OFDM) symbols (around 66 μs) of the uplink subframe on CH2 to sense if there is a Wi-Fi™ transmission on CH2. If the network load allows, the media sensing period can be 2-5 ms, to allow fair opportunity for WLAN to capture the channel.

The local area radio network base station can also introduce idle periods to allow Wi-Fi™ operation. Specifically, to offer the Wi-Fi™ system the possibility to start transmitting on CH2 as well, the local area radio network system can define idle periods. In the example of FIG. 2, 80% of the selected uplink subframes are not used for local area radio network transmissions. In other words, no user equipment is scheduled on these resources. If the uplink subframe duration is 0.5 ms, Wi-Fi™ will have duration of 0.4 ms to start transmissions on CH2. The access point can use carrier sensing at the end of the idle period to detect whether the medium is occupied by the wireless local area network. Without the idle periods, a local area radio network system may occupy the channel most of the time, and Wi-Fi™ will not be able to use the channel. In certain embodiments, the carrier sensing is used only at pre-defined time instances, particularly at instances relative to an intentional gap, and not before every transmission, although this is not mandatory. Additionally, the communications from any radio system utilizing a channel of interest may be detected, not only Wi-Fi™. Different radio systems, like digital enhanced cordless telecommunications (DECT) phones, Bluetooth®, ultra-wideband (UWB), etc. may apply different logic to co-exist. In some cases, the local area radio system can avoid the use of the secondary spectrum, or it may release it partially (for example, only use 10 MHz of the 20 MHz spectrum), or ignore the existence of the secondary system.

Also, the local area radio system may detect the physical layer (PHY) mode (802.11a/g,802.11n, 802.11ac) of the Wi-Fi™ radio to decide if the Wi-Fi™ radio is supporting the operation in secondary channels and whether co-existence at the channel is beneficial. If the Wi-Fi™ system is not capable of using secondary channels, the co-existence at the channel may not be beneficial, it may be beneficial to capture the whole channel and force Wi-Fi™ radio network to change its operating channel.

If there is no transmission on CH2 during the carrier sensing or idle period, the local area radio network base station will start to use CH2 in downlink (DL) and schedule users in uplink (UL). Please note that local area radio network terminals will not have to do carrier sensing before starting uplink transmissions.

If the local area radio network base station sensed that the media was busy during the carrier sensing or idle period, the local area radio network base station can avoid using the channel for a period time. This period of time can be labeled as LTE_Busy_Timeout, which is a value of timeout of the “busy” condition. A default value for LTE_Busy_Timeout may be approximately 100 ms. During this time, the wireless local area network will be able to use the channel without being disturbed by the local area radio network. After the LTE_Busy_Timeout period has expired, the local area radio network base station may redo carrier sensing and/or idle period to detect the availability of the channel. The value of LTE_Busy_Timeout may depend on the current and estimated future network load, quality of the secondary channel, and amount of alternative secondary channels.

The local area radio network base station can select the channels in which it uses carrier sensing. The local area radio network base station, for example, might not use carrier sensing on its primary channel, since the primary channel is not to be shared. Moreover, transmitting the broadcast channels and control channels at time instance defined by the standard may be one of the key building blocks and therefore using carrier sensing and skipping transmission could potentially harm reliable system operation. Further, the broadcast channels and control channels use heavy coding which tolerates interference from the Wi-Fi™ system.

At least one new idle period can be started after a maximum duration, which is illustrated as Max Period in FIG. 2. More frequent idle periods are allowed. The maximum duration may be defined in a standard or it may be agreed upon in a neighborhood around the local area radio network base station. The agreement around the local area radio network base station can be facilitated by a support node (SN). The local area radio network may be a synchronized system and consequently all local area radio network base stations can have their idle periods at the same time to allow Wi-Fi™ to start its operation on CH2.

If one local area radio network base station has multiple secondary channels, it may use carrier sensing at different times on different secondary channels. Thus, the carrier sensing windows of the secondary channels do not need to be synchronized. When the carrier sensing is synchronized among multiple secondary channels, some Wi-Fi™ implementations may take benefit of the carrier sensing synchronization and transmit especially at the carrier sensing times and purposely maintain the unnecessary channel reservation.

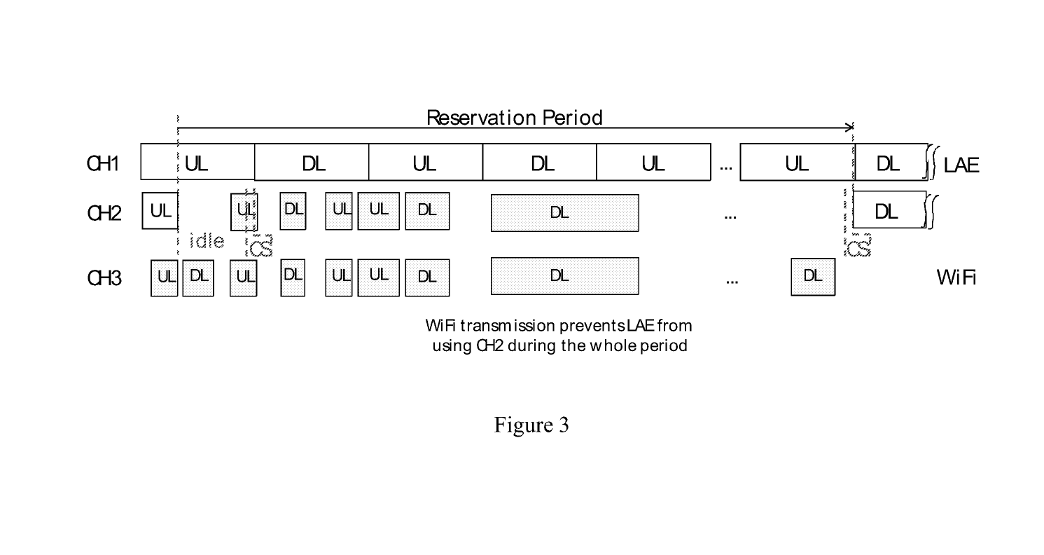

Carrier sensing during the idle period can be interpreted as reservation period. It is possible to implement the idle period and the following carrier sensing as a reservation for CH2 for the following reservation period of x frames or ms. In the case of FIG. 3, a Wi-Fi™ transmission occurs during the carrier sensing after the idle period and the local area radio network base station will not use CH2 for the whole duration of the reservation period.

Specifically, FIG. 3 illustrates an idle period and following carrier sensing used as reservation mechanism for the following reservation period. If Wi-Fi™ transmission occurs during the carrier sensing, it is reserved for Wi-Fi™ for the whole period and will not be used by the local area radio network. Similarly, if the other technology is detected, the applied procedure can be suitably selected, for example, halving the bandwidth, reserving the channel for other radio technology, or ignoring the radio technology for the whole period.

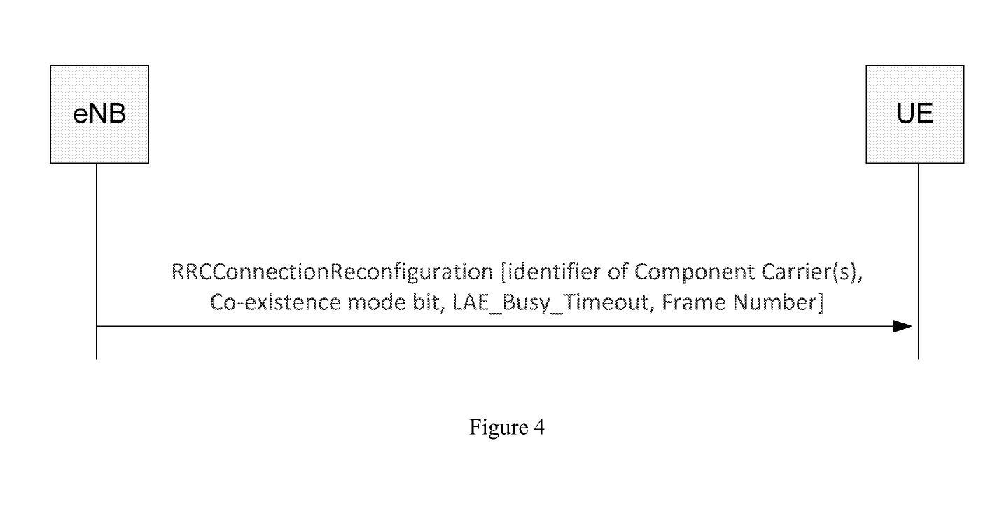

FIG. 4 illustrates signaling according to embodiment of the present invention. Signaling details of embodiments of the present invention may vary. The following discussion should be considered to be an example, and not limiting.

FIG. 4 specifically shows a radio resource control (RRC) message to reconfigure component carrier(s) to co-existence mode. The co-existence mode bit indicates that the component carrier is in co-existence mode, LTE_Busy_Timeout signals the reservation period, and frame number (relative offset to current frame) indicates when the sensing starts. This can be provided as a list of component carriers or it can be a bitmap of all the configured component carriers where the co-existence mode is taken into use.

If an user equipment has the component carrier configured as primary component carrier, the base station can initiate a handover of the user equipment to a new primary component carrier and configure the component carrier as secondary component carrier in co-existence mode (RRCConnectionReconfiguration message with LTE_Busy_Timeout and starting frame number for first reservation as information elements).

Additionally, the base station can inform the user equipment about another component carrier for which the secondary component carrier will be unavailable during the LTE_Busy_Timeout period. Informing can be performed as broadcast message in a system information block on a broadcast channel.

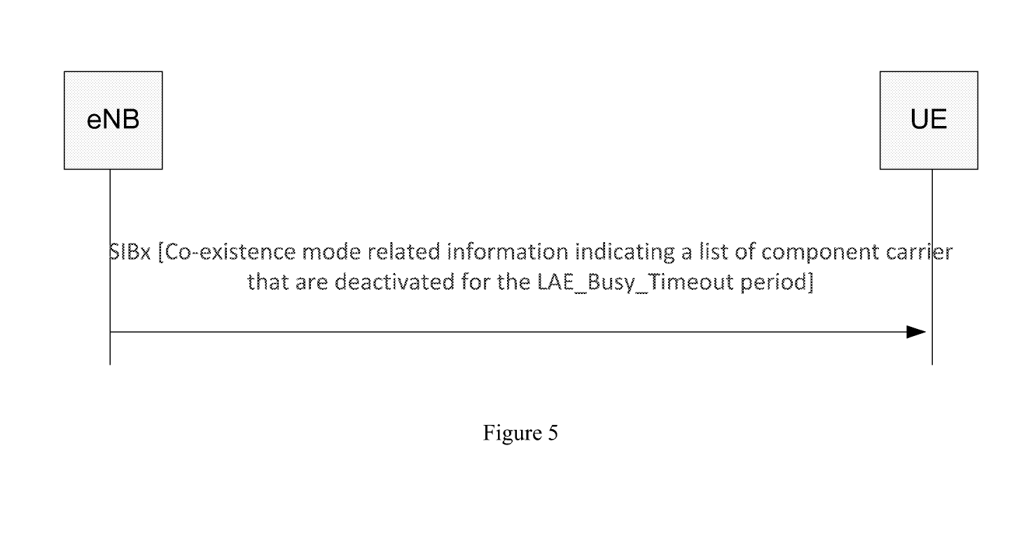

FIG. 5 illustrates a signaling mechanism according another embodiment of is the present invention. The illustrated system information block (SIB) can be broadcasted at the next possibility in downlink after the sensing happens. It can be broadcasted on one or more component carriers that are still active.

The options shown in FIGS. 4-5 may provide alternatives to a media access control (MAC) control element (CE) that is used to activate or deactivate a component carrier for each user equipment separately. The approach according to such embodiments may reduce signaling load in the system.

Certain embodiments of the present invention may have various advantages. For example, certain embodiments may permit local area radio network to co-exist with Wi-Fi™ network in the same neighborhood without completely damaging the Wi-Fi™ performance by constantly occupying the secondary channels

Moreover, certain embodiments may increase the acceptance of deploying local area radio network in areas where Wi-Fi™ is already present and may allow a gradual upgrade from Wi-Fi™ to a local area radio network. Additionally, certain embodiments may permit local area radio network and Wi-Fi™ network to share the same secondary channel without excessive signaling and heavy co-existence mechanism

Changes may only need to be made to the local area radio network, and thus the wireless local area network operation principles do need not be changed. The carrier sensing and idle periods can permit local area radio network to configure the likelihood of wireless local area network system channel allocation. On the other hand, if long idle periods are used, it is possible that wireless local area network will take over the channel.

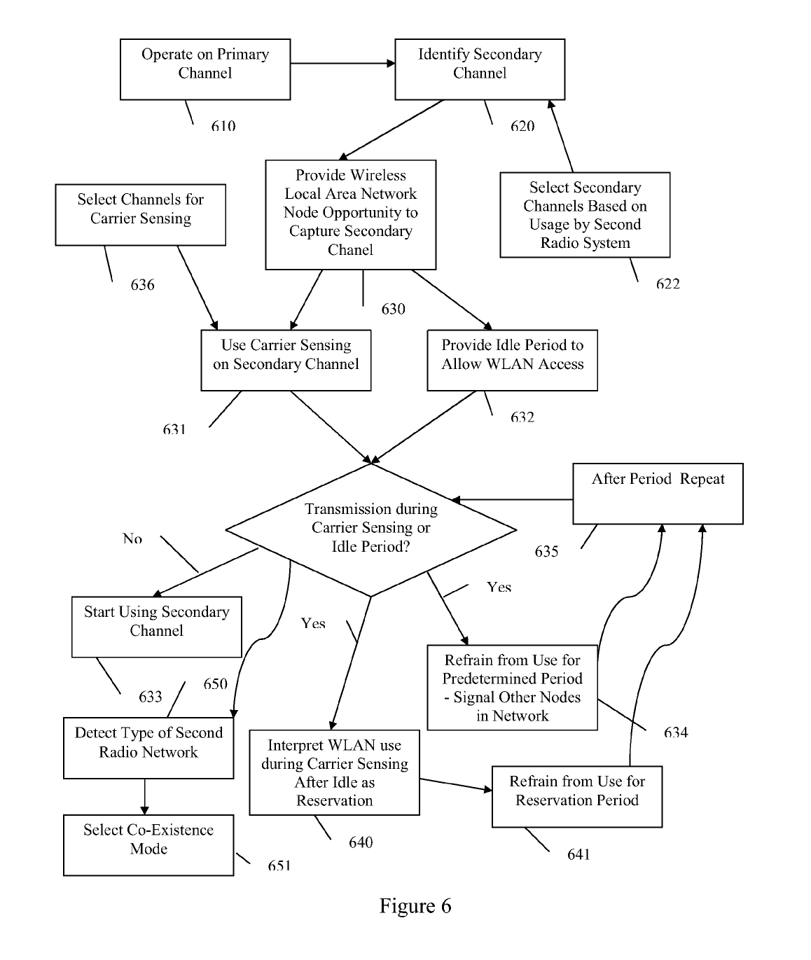

FIG. 6 illustrates a method according to certain embodiments of the present invention. As illustrated, the method includes, at 610, operating a first network node of a first radio network, for example a local area radio network node, on a primary channel. The method also includes, at 620, identifying a secondary channel for expanded operation of the first network node. At 622, the method can optionally include detecting that the second radio network is operating in a plurality of channels, and controlling the selecting of the channels to select the plurality of channels

The method can also include, at 630, providing a second network node, for example a wireless local area radio network node, with an opportunity to capture the secondary channel. The first network node may have multiple secondary channels and it may repeat the steps if necessary.

The method can further include, at 650, detecting a type of the second radio network when it is detected that the medium is occupied by the second radio network. When the type is not WiFi™, the method can include, at 651, selecting a coexistence mode of releasing the secondary channel, reducing the bandwidth of the secondary channel, or ignoring the second radio network

The method can also include, at 631, using carrier sensing on the secondary channel. The method can further include, at 632, providing an idle period to allow operation of the second network node. The carrier sensing can be performed at the end of the idle period to detect whether the medium is occupied by the second radio network.

If there is no transmission on the secondary channel during the carrier sensing or the idle period, the method includes, at 633, starting, by the first network node, use of the secondary channel in downlink or schedule users on the secondary channel in uplink.

If the media was sensed as busy during the carrier sensing or the idle period, the method includes, at 634, the first network node refraining from using the channel for a predetermined period of time. The predetermined period of time can be approximately 100 ms. If the media was sensed as busy during the carrier sensing or the idle period, the first network node signals other nodes of the first radio network that the secondary channel is deactivated for a pre-defined time, which may be the same as the predetermined period of time. The signaling can use a system information block or a media access control (MAC) control element transmitted immediately after the carrier sensing period.

After the predetermined period has expired, at 635, the first network node can repeat carrier sensing and/or idle period and determine the availability of the secondary channel. The method can also include, at 636, selecting, by the first network node, channels in which to use carrier sensing.

The providing the second network node with the opportunity to capture the secondary channel can be performed in synchronization with a third network node of the same type or same network as the first network node. The synchronization can include providing the idle period of the first network node at a same time as a corresponding idle period of the third network node.

The method can also include, at 640, interpreting, by the first network node, use of the secondary channel by the second radio network during the carrier sensing after the idle period as a reservation for a reservation period. The method can further include, at 641, refraining from using the secondary channel by the first network node during the reservation period.

The providing the second network node with the opportunity to capture the secondary channel is performed without any signaling between a network of the second network node and a network of the first network node.

The method illustrated in FIG. 6 can be performed by a computer readable medium encoded with computer instructions that, when executed in hardware, perform the method.

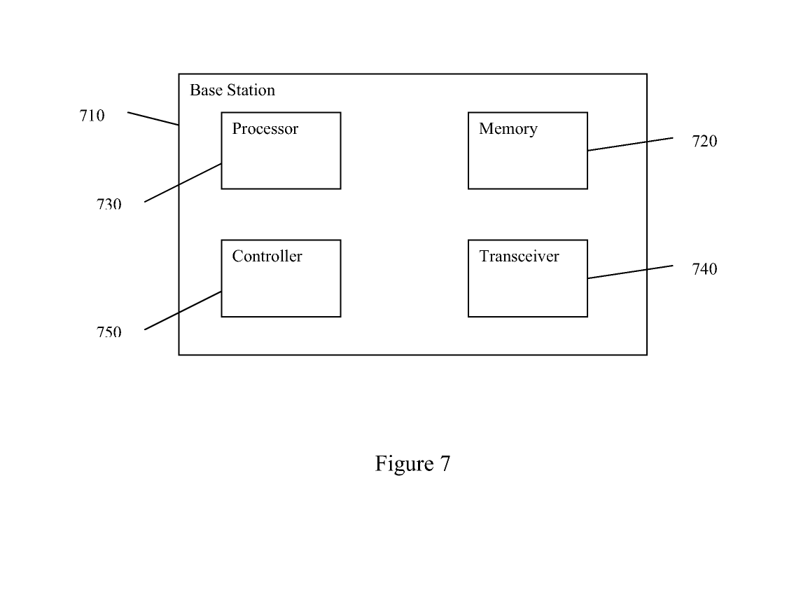

FIG. 7 illustrates an apparatus according to certain embodiments of the present invention. The apparatus can be a base station 710 or similar access point device. The apparatus can include a memory 720, which can include computer program code. The memory 720 can be any suitable type of memory, such as a non-transitory computer-readable medium, a hard disk drive, a random access memory (RAM), or memory on a chip. The computer program code can be any kind of computer program instructions, including compiled programs and interpreted programs.

The apparatus can also include a processor 730. The processor 730 can be a single device or a plurality of devices, such as chips. More than one processor 730 can be included in the apparatus. The processor 730 can be operably connected to the memory 720 and can, in certain embodiments, be on the same chip as the memory 720.

The apparatus can also include a transceiver 740. The transceiver 740 can be configured to communicate with other devices in a wireless or wired network. For example, the transceiver 740 can be configured to listen for communications from a WLAN, such as Wi-Fi™, and to communicate with user equipment of local area radio network. The transceiver 740 can be operably connected to the processor 730, and the memory 720, and can be partially or full integrated or separated from them.

The apparatus can additionally include controller 750. Controller 750 can control the operations of the apparatus, working in harmony with the processor 730, memory 720, and transceiver 740 to perform various tasks. Thus, for example, the apparatus can be configured to perform the method illustrated in FIG. 6 using the processor, memory, transceiver, and controller.

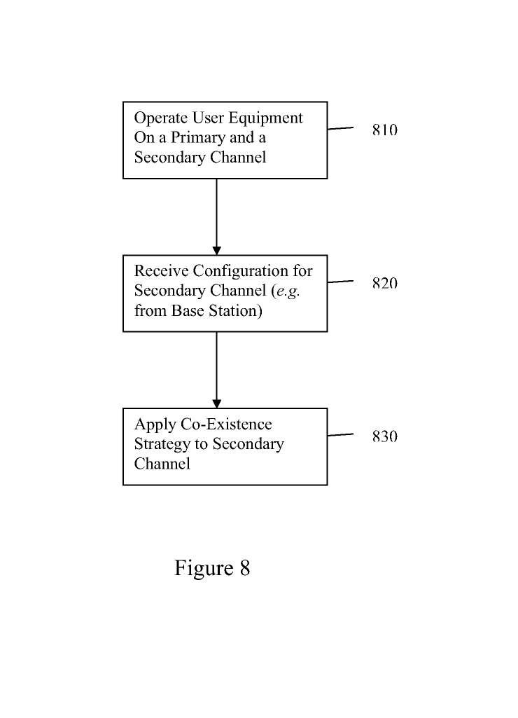

FIG. 8 illustrates another method according to certain embodiments of the present invention. As shown in FIG. 8, a method can include, at 810, operating a network node in a first radio network on a primary channel and a secondary channel. The method can also include, at 820, receiving, at the network node, a configuration that the secondary channel is in co-existence mode. The method can further include, at 830, applying a co-existence strategy to operation in the secondary channel.

The co-existence strategy can include treating the secondary channel as de-activated for a designated time period. Alternatively, the co-existence strategy can include refraining from monitoring the packet data control channel on the secondary channel for a designated time period and monitoring the packet data control channel again after the time period has elapsed. The designated time period can be determined by a standard or signaled to the network node. The method can be performed by a user equipment.

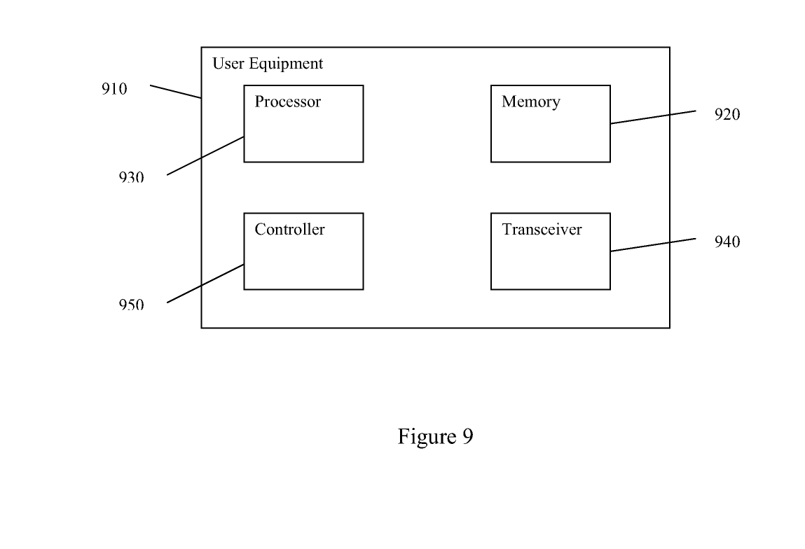

FIG. 9 illustrates an apparatus according to certain embodiments of the present invention. The apparatus can be a user equipment 910 or similar terminal device. The apparatus can include a memory 920, which can include computer program code. The memory 920 can be any suitable type of memory, such as a non-transitory computer-readable medium, a hard disk drive, a random access memory (RAM), or memory on a chip. The computer program code can be any kind of computer program instructions, including compiled programs and interpreted programs.

The apparatus can also include a processor 930. The processor 930 can be a single device or a plurality of devices, such as chips. More than one processor 930 can be included in the apparatus. The processor 930 can be operably connected to the memory 920 and can, in certain embodiments, be on the same chip as the memory 920.

The apparatus can also include a transceiver 940. The transceiver 940 can be configured to communicate with other devices in a wireless or wired network. For example, the transceiver 940 can be configured to listen for communications from a WLAN, such as Wi-Fi™, and to communicate with user equipment of local area radio network. The transceiver 940 can be operably connected to the processor 930, and the memory 920, and can be partially or full integrated or separated from them.

The apparatus can additionally include controller 950. Controller 950 can control the operations of the apparatus, working in harmony with the processor 930, memory 920, and transceiver 940 to perform various tasks. Thus, for example, the apparatus can be configured to perform the method illustrated in FIG. 8 using the processor, memory, transceiver, and controller.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, although Wi-Fi™ is frequently mentioned, it should be understood to be just one example of a wireless local area network. In order to determine the metes and bounds of the invention, therefore, reference should be made to the appended claims.

1-78. (canceled)

79. A method, comprising:
operating a first network node of a first radio network on a primary channel;
identifying a secondary channel for expanded operation of the network node; and
providing a second network node of a second radio network with an opportunity to capture the secondary channel.

80. The method of claim 79, wherein the providing the second network node with the opportunity to capture the secondary channel comprises at least one of: using carrier sensing on the secondary channel, comprises providing an idle period to allow operation of the second network node.

81. The method of claim 80, further comprising:
determining, by the first network node or by another node in the first radio network, that there is no transmission on the secondary channel during the carrier sensing or the idle period

82. The method of claim 81, wherein, if there is no transmission on the secondary channel during the carrier sensing or the idle period, starting, by the first network node, use of the secondary channel in downlink or schedule users on the secondary channel in uplink

83. The method of claim 80, wherein if the media was sensed as busy during the carrier sensing or the idle period, the first network node refrains from using the channel for a predetermined period of time.

84. The method of claim 83, wherein after the predetermined period has expired, the first network node repeats carrier sensing and/or idle period and determines the availability of the secondary channel.

85. The method of claim 79, wherein the providing the second network node with the opportunity to capture the secondary channel is performed in synchronization with a third network node.

86. The method of claim 85, wherein the synchronization comprises providing the idle period of the first network node at a same time as a corresponding idle period of the third network node.

87. The method of claim 80, further comprising:
interpreting, by the first network node, use of the secondary channel by the second radio network during the carrier sensing after the idle period as a reservation for a reservation period.

88. A computer readable medium encoded with computer instructions that, when executed in hardware, perform a method of claim 79.

89. An apparatus, comprising:
at least one memory including computer program instructions; and
at least one processor,
wherein the at least one memory and the computer program instructions are configured to, with the at least one processor, cause the apparatus at least to
operate a first network node of a first radio network on a primary channel;
identify a secondary channel for expanded operation of the first network node; and
provide a second network node with an opportunity to capture the secondary channel.

90. The apparatus of claim 89, wherein the at least one memory and the computer program instructions are configured to, with the at least one processor, cause the apparatus at least to provide the second network node with the opportunity to capture the secondary channel by at least one of: using carrier sensing on the secondary channel, providing an idle period to allow operation of the second network node.

91. The apparatus of claim 90, wherein the at least one memory and the computer program instructions are configured to, with the at least one processor, cause the apparatus at least to determine, by the first network node or by another node in the first radio network, that there is no transmission on the secondary channel during the carrier sensing or the idle period

92. The apparatus of claim 91, wherein, if there is no transmission on the secondary channel during the carrier sensing or the idle period, the at least one memory and the computer program instructions are configured to, with the at least one processor, cause the apparatus at least to start use of the secondary channel in downlink or schedule users on the secondary channel in uplink

93. The apparatus of claim 90, wherein, if the media was sensed as busy during the carrier sensing or the idle period, the at least one memory and the computer program instructions are configured to, with the at least one processor, cause the apparatus at least to refrain from using the channel for a predetermined period of time.

94. The apparatus of claim 93, wherein after the predetermined period has expired, the at least one memory and the computer program instructions are configured to, with the at least one processor, cause the apparatus at least to repeat carrier sensing and/or idle period and determine the availability of the secondary channel.

95. The apparatus of claim 89, wherein the at least one memory and the computer program instructions are configured to, with the at least one processor, cause the apparatus at least to provide the second network node with the opportunity to capture the secondary channel in synchronization with a third network node.

96. The apparatus of claim 95, wherein the synchronization comprises providing the idle period of the first network node at a same time as a corresponding idle period of the third network node.

97. The apparatus of claim 90, wherein the at least one memory and the computer program instructions are configured to, with the at least one processor, cause the apparatus at least to interpret use of the secondary channel by the second radio network during the carrier sensing after the idle period as a reservation for a reservation period.

98. A method, comprising:
operating a network node in a first radio network on a primary channel and a secondary channel;
receiving, at the network node, a configuration that the secondary channel is in co-existence mode; and
applying a co-existence strategy to operation in the secondary channel.

99. The method of claim 98, wherein the co-existence strategy comprises treating the secondary channel as de-activated for a designated time period.

100. An apparatus, comprising:
at least one memory including computer program instructions; and
at least one processor,
wherein the at least one memory and the computer program instructions are configured to, with the at least one processor, cause the apparatus at least to
operate a network node in a first radio network on a primary channel and a secondary channel;
process a received configuration that the secondary channel is in co-existence mode; and
apply a co-existence strategy to operation in the secondary channel.

101. The apparatus of claim 100, wherein the co-existence strategy comprises treating the secondary channel as de-activated for a designated time period.
